(19) United States
(12) Patent Application Publication
(10) Pub. No.: US 2002/0180070 A1
(43) Pub. Date: Dec. 5, 2002

(54) Unit for contacting liquid and fumes provided with a safety liquid reserve, and method for feeding said reserve

(76) Inventors: Jacques Woillez, Lyon (FR); Fabrice Gourmelon, Lyon (FR)

Correspondence Address: Ralph A Dowell, Dowell & Dowell, Suite 309, 1215 Jefferson Davis Highway, Arlington, VA, 22202, US

(21) Appl. No.: 10/148,478

(22) PCT Filed: Dec. 1, 2000
(86) PCT No.: PCT/FR00/03367

(30) Foreign Application Priority Data
Dec. 2, 1999 (FR) 99 15219

(51) Int. Cl. B01F 3/04

(52) U.S. Cl. 261/3; 261/36.1; 261/115; 261/DIG. 9; 96/235; 95/187

(57) ABSTRACT

The invention concerns a unit (10) comprising a chamber (4) for contacting liquid and fumes, means (10, 12) for distributing liquid into said chamber (4), a circuit (14) feeding the distributing means (10, 12) with liquid, comprising in particular a pump (16), a safety liquid reserve (10 arranged at a level higher than that of said chamber (4) and means for transferring (22, 26) said liquid by gravity, from the reserve to the feeding circuit. The transfer means (22, 26) are adapted to enable the liquid to flow in both ascending and descending directions, said flow being constantly possible in at least one of the two directions and occurring in one direction or the other depending on pressure conditions prevailing in the feeder circuit.

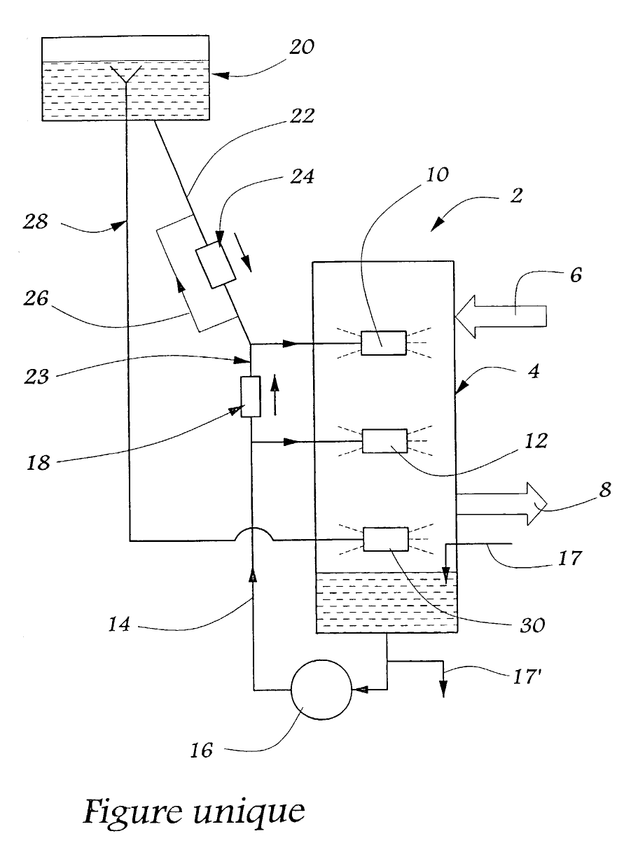

The present invention relates to a unit for contacting liquid and fumes provided with a safety liquid reserve, as well as to a method for feeding this reserve.

In the domain of the treatment of industrial fumes, such a contacting unit ensures cooling of the fumes which are admitted therein as well, if necessary, as the collection of the pollutants initially present in these fumes. In this latter configuration, this unit is in that case called wet washer.

A unit for contacting liquid and fumes conventionally comprises a chamber in which the gases to be treated are admitted and from which the cooled gases are evacuated. Liquid distribution means, such as sprays or linings, are disposed inside this chamber. Furthermore, a circuit for recycling the liquid is provided, extending between the bottom of the chamber and the distribution means, as well as supply and bleed lines, at least one pump ensuring entrainment of the liquid along this circuit.

In the event of breakdown of these pumps, the envelope of the chamber is subjected to a heating due to the arrival of non-cooled fumes, in particular when this envelope is made of plastics material. In order to overcome a possible failure of these pumps, it is known to arrange a safety liquid reserve. This reserve, whose level is permanently controlled by a valve, is located above the chamber and is placed in communication with the circuit for recycling the liquid via a conduit, on which an admission valve, which is closed in normal operation, is interposed.

When a failure of the pumps occurs, the admission valve is opened so as to transfer by gravity the volume of the liquid initially contained in the reserve. This contributes to the cooling of the chamber, before an interruption of the feed of hot fumes is proceeded with.

This known solution presents certain drawbacks. In effect, satisfactory implementation of this safety reserve requires, on the one hand, that its filling be permanently sufficient and, on the other hand, that the volume of liquid admitted therein be able to flow reliably towards the chamber of the unit. This involves correct functioning of the valve controlling the level of the reserve, as well as of the valve for admission of the liquid towards the chamber. Being given that these control members are capable of breaking down, they are often provided in duplicate, which involves considerable investments.

Moreover, the liquid contained in the safety reserve constitutes a dead volume, which does not contribute to carrying out the process of cooling and, if necessary of collection. When this liquid is emptied, it is necessary to recover it within an annexed volume, generally the lower part of the chamber. This induces an overdimensioning of the unit and increases the cost thereof.

When the reserve is implanted in the ambient air, it is necessary to provide a device for reheating this reserve so as to maintain it permanently protected from frost. This involves additional costs, in particular in terms of energy.

Finally, when the cooling liquid conveys solid matter in suspension, the zone of junction between the recycling circuit and the conduit placing the reserve in communication with the chamber, forms a dead zone, which is capable of being blocked by this solid matter at least partially. In this eventuality, a reliable flow of the safety liquid in the direction of the chamber is not guaranteed, which may compromise the integrity of this chamber.

The invention proposes to produce a unit for contacting liquids and fumes provided with a liquid reserve allowing these different drawbacks to be overcome.

To that end, it has for its object a unit for contacting liquid and fumes, comprising a chamber for contacting liquid and fumes, means for distributing the liquid into said chamber, a circuit feeding the distributing means with liquid, comprising in particular a pump, said unit further comprising a safety liquid reserve arranged at a level higher than that of said chamber and means for transferring said liquid by gravity from the reserve to the feeding circuit, characterized in that the transfer means are adapted to enable the liquid to flow in both ascending and descending directions, said flow being constantly possible in at least one of the two directions and occurring in one direction or the other depending on the pressure conditions prevailing in the feeding circuit.

According to other characteristics of the invention:

means for returning the liquid from the reserve towards the chamber are provided, independent of the feeding circuit and the transfer means.

said return means are adapted to be fed by an overflow of the reserve.

said return means are connected to additional means for distributing the liquid inside the chamber.

the transfer means are adapted to ensure a flowrate of liquid, in the ascending direction, substantially less than the flowrate of liquid in the descending direction.

the transfer means comprise a conduit presenting a first section of passage and which is provided with a member allowing passage of the liquid solely in the descending direction, particularly a non-return valve, as well as a by-pass connected on said conduit and extending on either side of said member, said by-pass presenting a second section of passage, substantially smaller than said first section.

the ratio between the first section and the second section is included between 1.5 and 10, preferably between 2 and 5.

the transfer means comprise a single conduit connecting the reserve and the supply circuit, the ratio between the section of passage of the portion of the feeding circuit adjacent this conduit and the section of passage of this single conduit being included between 3 and 10, preferably between 5 and 8.

The invention also relates to a method for feeding a safety liquid reserve belonging to a unit for contacting liquid and fumes, said unit comprising a chamber for contacting the liquid and the fumes, arranged at a level lower than that of said reserve, means for distributing the liquid in said chamber, a circuit for feeding the liquid distribution means, comprising in particular a pump, said unit further comprising means for transferring said liquid by gravity from the reserve towards the feeding circuit, characterized in that said reserve is continuously fed from said supply circuit via said pump.

According to other characteristics of the invention:

the transfer means are adapted to ensure a flowrate of liquid, in the ascending direction, substantially less than the flowrate of liquid in the descending direction and said reserve is fed from the feeding circuit at a flowrate included between 30 and 70%, preferably between 40 and 60%, of the flowrate of liquid inside the portion of said feeding circuit adjacent the transfer means.

the transfer means comprise a single conduit connecting the reserve and the feeding circuit and in that the reserve is fed from the feeding circuit at a flowrate included between 50 and 100%, preferably between 65 and 85% of the flowrate of liquid inside the portion of the feeding circuit adjacent this single conduit.

said reserve is fed in overflow.

there is added in the internal volume of the reserve at least one reagent allowing the initiation of a chemical reaction in said reserve.

The invention will be described hereinbelow with reference to the accompanying single FIGURE given solely by way of non-limiting example, which is a schematic representation of a unit according to the invention for contacting liquid and fumes.

The unit for contacting liquid and fumes illustrated in the FIGURE is a washer, generally designated by reference 2. This washer comprises a cylindrical chamber 4 whose internal volume is placed in relation with a pipe 6 for admission of the gases to be treated, as well as with a pipe 8 for exit of the cooled gases.

Two sprays 10, 12 are arranged one above the other in the chamber 4. They form two stages of distribution of liquid within this chamber and are fed by a recycling line 14 extending from the bottom of the chamber 4 in the direction of each spray 10, 12, a pump 16 making it possible to convey this liquid along the line 14.

Furthermore, liquid supply (17) and bleed (17′) pipes are provided, as well as a non-return valve 18, disposed on the section of the line 14 located between the two sprays 10, 12. This non-return valve ensures the passage of the liquid only in the ascending direction, namely in the direction of the upper spray 10.

The washer 2 is provided with a safety liquid reserve, which is formed by a tank 20 in communication with the recycling line 14. To that end, a conduit 22 extends between the bottom of the tank 20 and the upper part of the recycling line 14, disposed above the non-return valve 18. The diameter of this conduit 22 is close to that of the portion 23 of the line 14 placed adjacent this conduit. The conduit 22 is provided with a non-return valve 24, which allows the flow of the liquid solely in the descending direction, i.e. from the tank 20 towards the recycling line 14.

A by-pass 26, which is connected on conduit 22, extends on either side of the non-return valve 24. This by-pass is adapted to ensure a flowrate of liquid substantially less than that of the liquid circulating in the line 14 or in the conduit 22. To that end, the ratio of the sections of passage, S and s, of the conduit 22 and of the by-pass 26 is included between 1.5 and 10, preferably 2 and 5. The by-pass may be of constant section or present a localized restriction.

A pipe 28 places the tank 20 in relation with the internal volume of the chamber 4. This pipe 28, which is adapted to recover the overflow of the tank 20, feeds an additional spray 30, disposed below spray 12. This pipe 28, which is not placed in communication with the recycling line 14, presents a section of passage similar to that of this recycling line.

Functioning of the washer 2 and of its safety liquid reserve 20 will now be explained.

In normal operational mode, the pump 16 conveys liquid in the recycling line 14, which allows cooling of the internal volume of the chamber 4 via sprays 10, 12. Such cooling guarantees the mechanical integrity of the envelope of the chamber 4, with the result that it is not necessary to resort to any volume of safety liquid.

Furthermore, the pump feeds the conduit 22. Due to the presence of the non-return valve 24, the liquid set in motion by the pump is transferred towards the tank 20, solely by the by-pass 26 of small section. The flowrate of liquid admitted in this by-pass is typically included between 30 and 70%, preferably between 40 and 60% of the flowrate of liquid circulating in the portion 23 of recycling line 14 disposed in the vicinity of conduit 22.

The liquid directed by the by-pass 26 continuously feeds the tank 20, with the result that the latter is, in normal regime, in permanent overflow. The liquid overflowing from the tank 20 flows by gravity in the pipe 28 then is distributed in the internal volume of the chamber 4, by the spray 30.

When the washer 2 is started up, the tank 20 is empty and it is preferable to wait until it is completely filled before admitting hot fumes in the chamber 4, via the pipe 6.

In normal regime, it is possible to add, in the tank 20, chemical reagents which allow reactions aiming at the purification of the fumes admitted in the chamber 4.

When the pump 16 no longer functions, it no longer ensures circulation of the liquid along the line 14 and the by-pass 26. This absence of ascending movement of the liquid in the by-pass 26 induces the flow, by gravity, of the liquid initially present in the tank 20. This liquid is transferred towards the circuit 14 at a flowrate clearly higher than that of the ascending liquid, insofar as it is able to take the conduit 22 of large section, the non-return valve 24 being open.

Only the upper spray 10 is fed by the liquid initially present in the tank 20, due to the presence of the non-return valve 18. In a variant, a plurality of sprays may be provided at the level of this upper stage, or a plurality of upper stages may be provided to be fed. The spraying of the liquid allows the cooling of the internal volume of the chamber for a duration which makes it possible to proceed with the interruption of the admission of fumes via the pipe 6. Once the pump is returned into service, the tank 20 is filled before fumes are re-admitted via this pipe 6, as explained hereinabove.

The invention is not limited to the examples described and shown.

For example, it may be envisaged to replace the conduit 22 and its by-pass 26 by a single conduit connecting the feeding and recycling circuit 14 and the tank 20. This single conduit in that case ensures the circulation of liquid between the circuit 14 and the tank 20, in the ascending and descending directions. The section of passage of this single conduit is fixed so as to ensure a sufficient flowrate in descending gravity mode, from the tank 20 in the direction of the spray 10. To that end, the ratio between, on the one hand, the section of passage of the portion 23 of the line 14 adjacent this conduit and, on the other hand, the section of passage of this single conduit, is included between 3 and 10, preferably between 5 and 7. This single conduit is fed with liquid, at a flowrate included between 30 and 90%, preferably between 50 and 75%, of the flowrate of liquid circulating in the line 14.

The invention enables the afore-mentioned objects to be attained since it makes it possible to satisfactorily overcome possible breakdowns of the liquid circulation pumps.

In effect, the safety reserve permanently contains a sufficient volume of liquid, insofar as this reserve is fed continuously from the line recycling the liquid. This filling, which is automatic, does not require the use of a monitoring member. This is to be compared with the prior art in which a valve for monitoring the level is employed.

Moreover, the transfer of the volume of liquid contained in this reserve, in the direction of the chamber, is effected reliably in the event of failure of the pump, since it is precisely the fact that this pump is taken out of service which provokes such a transfer, by gravity. This is to be compared with the prior art in which the flow of the volume of safety liquid is subordinate to the opening of an inlet valve.

According to the invention, the mechanical integrity of the chamber is automatically ensured without resorting to monitoring and triggering members. By doing without such members, there is therefore a significant decrease, with respect to the prior art, of the investment and operational costs of the unit of the invention.

When the safety reserve of the unit of the invention is in the ambient air, it is not necessary to add any heating device thereto, insofar as it is either empty or permanently fed with hot water, with the result that it is not subject to frost. This represents an additional source of reduction of costs with respect to the prior art.

The unit according to the invention avoids, to a wide extent, any blocking by matter in suspension. In effect, the zone of join between the recycling line 14 and the conduit 22 for feeding the tank 20 is the place of a permanent flow of hot liquid, which eliminates the risk of accumulation of this solid matter.

It is advantageous to provide transfer means ensuring an ascending flow of liquid with a flowrate less than that of the descending flow. In effect, in the ascending direction, the low flowrate allowed induces only a slight additional consumption of energy, at the level of the circulation pump. Furthermore, the high flowrate allowed in the descending direction guarantees rapid cooling of the internal volume of the chamber.

To provide means for returning the overflow of the tank in the direction of the chamber is advantageous, in terms of consumption of liquid. This measure is particularly advantageous when these return means allow feed of an additional spray, effecting an additional cooling.

To add chemical reagents in the internal volume of the reserve guarantees a particularly judicious use of the latter. This measure makes it possible to initiate, in the reserve itself, chemical reactions connected with the collection of the pollutants. Moreover, this reserve is particularly easy to access, which is to be compared with the prior art in which it is provided to add reagents in the lower part of the chamber, whose access is difficult.

1. Unit (2) for contacting liquid and fumes, comprising a chamber (4) for contacting liquid and fumes, means (10, 12) for distributing the liquid into said chamber (4), a circuit (14) feeding the distributing means (10, 12) with liquid, comprising in particular a pump ( 16), said unit further comprising a safety liquid reserve (20) arranged at a level higher than that of said chamber (4) and means (22, 26) for transferring said liquid by gravity from the reserve to the feeding circuit, characterized in that the transfer means (22, 26) are adapted to enable the liquid to flow in both ascending and descending directions, said flow being constantly possible in at least one of the two directions and occurring in one direction or the other depending on the pressure conditions prevailing in the feeding circuit (14).

2. Unit according to claim 1, characterized in that means (28, 30) for returning the liquid from the reserve (20) towards the chamber (4) are provided, independent of the feeding circuit (14) and of the transfer means (22, 26).

3. Unit according to claim 2, characterized in that said return means (28) are adapted to be fed by an overflow of the reserve (20).

4. Unit according to claim 2 or 3, characterized in that said return means are connected to additional means (30) for distributing the liquid inside the chamber (4).

5. Unit according to one of claims I to 4, characterized in that the transfer means (22, 26) are adapted to ensure a flowrate of liquid, in the ascending direction, substantially less than the flowrate of liquid in the descending direction.

6. Unit according to claim 5, characterized in that the transfer means comprise a conduit (22) presenting a first section of passage (S) and which is provided with a member (24) allowing passage of the liquid solely in the descending direction, particularly a non-return valve, as well as a by-pass (26) connected on said conduit (22) and extending on either side of said member (24), said by-pass presenting a second section of passage (s), substantially less than said first section (S).

7. Unit according to claim 6, characterized in that the ratio between the first section (S) and the second section (s) is included between 1.5 and 10, preferably between 2 and 5.

8. Unit according to one of claims 1 to 4, characterized in that the transfer means comprise a single conduit connecting the reserve (20) and the feeding circuit (14), the ratio between the section of passage of the portion (23) of the feeding circuit adjacent this conduit and the section of passage of this single conduit being included between 3 and 10, preferably between 5 and 8.

9. Method for feeding a safety liquid reserve (20) belonging to a unit (2) for contacting liquid and fumes, said unit comprising a chamber (4) for contacting the liquid and the fumes, disposed at a level lower than that of said reserve (20), means (10, 12) for distributing the liquid in said chamber (4), a circuit (14) for feeding the distribution means (10, 12) with liquid, comprising in particular a pump (16), said unit further comprising means for transferring said liquid by gravity from the reserve towards the feeding circuit, characterized in that said reserve (20) is continuously fed from said feeding circuit (14) via said pump (16).

10. Method according to claim 9, characterized in that the transfer means (22, 26) are adapted to ensure a flowrate of liquid, in the ascending direction, substantially less than the flowrate of liquid in the descending direction and in that said reserve (10) is fed from the feeding circuit (14) at a flowrate included between 30 and 70%, preferably between 40 and 60%, of the flowrate of liquid inside the portion (23) of said feeding circuit (14) adjacent to the transfer means (22, 26).

11. Method according to claim 9, characterized in that the transfer means comprise a single conduit connecting the reserve (10) and the feeding circuit (14) and in that the reserve (10) is fed from the feeding circuit (14) at a flowrate included between 50 and 100%, preferably between 65 and 85% of the flowrate of liquid inside the portion (23) of the feeding circuit (14) adjacent this single conduit.

12. Method according to one of claims 9 to 11, characterized in that said reserve (10) is fed in overflow.

13. Method according to one of claims 9 to 12, characterized in that there is added in the internal volume of the reserve (10) at least one reagent allowing the initiation of a chemical reaction in said reserve (20).
